(19) United States
(12) Patent Application Publication
(10) Pub. No.: US 2016/0277988 A1
(43) Pub. Date: Sep. 22, 2016

(54) OPTIMIZED OPERATION OF A MOBILE DEVICE

(71) Applicant: MYOMEGA SYSTEM TECHNOLOGIES, Nuemberg (DE)

(72) Inventors: Bernd Moeller, Henfenfeld (DE); Juergen Bohn, Langensendelbach (DE)

(21) Appl. No.: 15/034,580

(22) PCT Filed: Nov. 6, 2014
(86) PCT No.: PCT/EP2014/073896

§ 371 Date: May 5, 2016

(30) Foreign Application Priority Data
Nov. 6, 2013 (DE) 13191826.0

(51) Int. Cl. H04W 36/24; H04W 36/14; H04W 36/30; H04W 4/00; H04W 36/08; H04W 24/10

(52) U.S. Cl. CPC H04W 36/245; H04W 36/08; H04W 24/10; H04W 36/30; H04W 4/008; H04W 36/14; H04W 88/08

(57) ABSTRACT

Disclosed is a method, comprising: recording a sequence of data sets by a mobile computing device to obtain a recorded sequence of data sets; comparing by the mobile computing device the recorded sequence of data sets with a stored sequence of data sets; performing at least one activity by the mobile device associated with the stored sequence of data sets when the recorded sequence of data sets matches the stored sequence of data sets.

Embodiments of the present invention relate to an optimized operation of a mobile device (user equipment), such as optimized user behavior in heterogeneous networks such as handovers and optimized transitions to non-cellular wireless systems. Heterogeneous monitoring of wireless environments triggered by the user equipment will lead to an improved heterogeneous behavior towards setups like in-building communication, small multi-cell arrays of wireless networks, or combinations thereof. The user equipment will need to trigger decisions in heterogeneous setups with weak or no indoor cellular coverage (such as LTE, 3G and 2G), and available wireless (e.g., Wi-Fi) and capillary networks (e.g., Z-Wave).

A mobile communication system (that can also be referred to as wireless communication system) includes a plurality of base stations. Also multiple mobile technologies, such as LTE, 3G and 2G, and non-cellular technologies, such as WIFI, can be combined into a heterogeneous network where a plurality of base stations provides service to mobile devices, such as mobile phones, mobile computers, or the like, that are currently located in a geographical area covered by at least one base station. The geographical area covered by one base station is often referred to as radio cell. A mobile device can be connected to a mobile or non-cellular communication system through one or more base stations through at least one wireless communication channel in order to uses services of the mobile communication system. Examples of those services include setting up telephone calls to other users coupled to the mobile communication system, downloading/uploading data from/to a data server coupled to the mobile communication systems, establishing and maintaining the status related to the mobile systems.

When the mobile device is connected to one base station and moves from the radio cell associated with this base station to a radio cell associated with another base station, a network controller will decide on a handover. That is, the network controller will initiate handover procedures such that the mobile device can be connected to the other base station, and therefore the mobile device can continue to use services from the mobile communication system.

The handover decision taken by the network controller can be based on criteria reported by the mobile device through the base station. These criteria include, for example, the RF levels and the quality (signal to noise and interference ratio) of radio signals received by the mobile device from the base station to which the mobile device is connected to, and from other base stations.

The reports provided by the mobile device, and the communication between the network controller and the base stations involved in a handover may provide a significant load to the communication system.

The problem underlying the present invention is to improve the services for the user within a heterogeneous communication system by utilizing the capabilities of mobile computing devices within heterogeneous environments that do not all provide the necessary network management capabilities like, for example, cellular networks (e.g., LTE) managed by an operator (e.g., T-Mobile), and to offload the systems or to support missing network management decision capabilities.

The problem will be intensified by the notion that, in the coming years, available bandwidth is expected to become a continuously scarcer resource due to the exponentially increasing quantity and density of network-enabled devices that compete for the bandwidth in heterogeneous cellular, wireless and capillary networks. Therefore methods such as de-centralized handover decisions in cases where networks do not provide such functions and the support of decisions that guarantee service continuity will be key.

This problem is solved by a method in accordance with claim 1. Embodiments are disclosed in the dependent claims.

A method in accordance with one embodiment of the invention includes recording a sequence of data sets by a mobile device to obtain a recorded sequence of data sets; comparing by the mobile device the recorded sequence of data sets with a stored sequence of data sets stored in the mobile device; and per-forming by the mobile device at least activity associated with the stored sequence of data sets when the recorded sequence of data sets matches the stored sequence of data sets.

Examples are explained below with reference to the drawings. These drawings serve to illustrate certain principles, so that only aspects necessary for understanding these principles are illustrated. The drawings are not to scale. In the drawings the same reference characters denote like features.

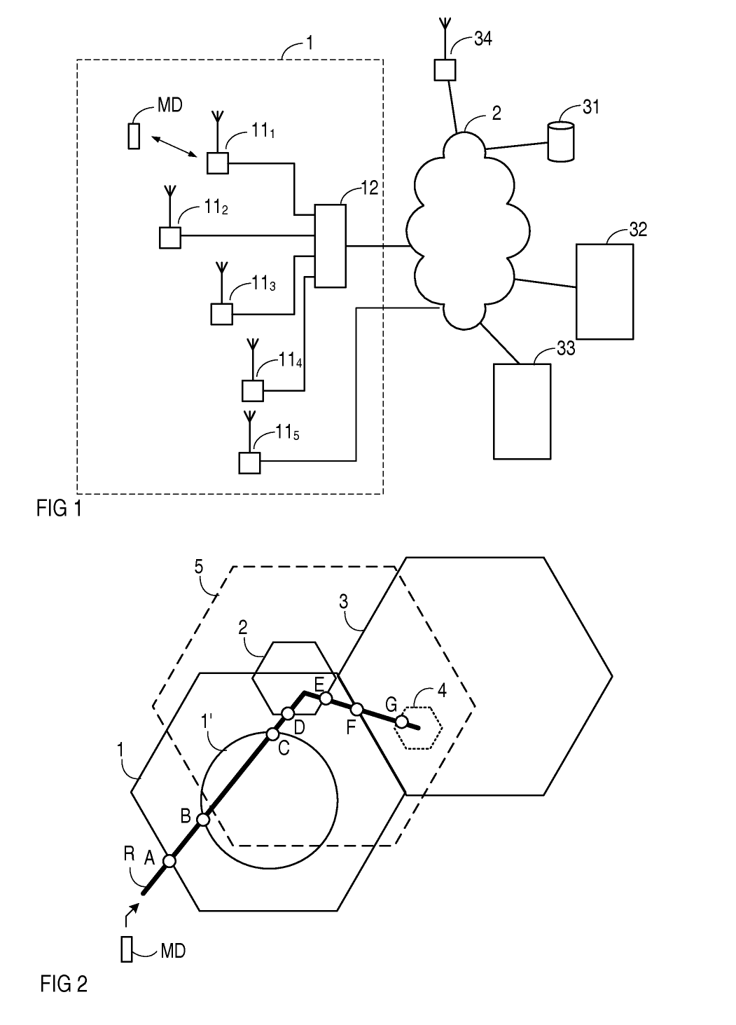

FIG. 1 schematically illustrates one embodiment of a mobile communication system,

FIG. 2 schematically illustrates several radio cell scenarios and a path of a user equipment through some of these radio cells,

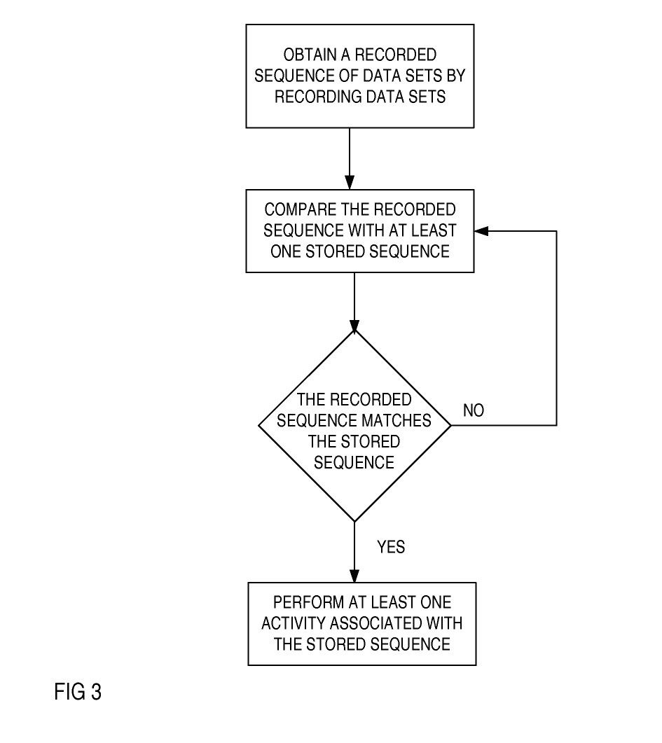

FIG. 3 illustrates one embodiment of a method performed by a user equipment.

One embodiment of a method for optimizing network activity includes recording a sequence of data sets by a mobile device to obtain a recorded sequence of data sets; comparing by the mobile device the recorded sequence of data sets with a stored sequence of data sets stored in the mobile device; and performing by the mobile device at least activity associated with the stored sequence of data sets when the recorded sequence of data sets matches the stored sequence of data sets. In particular, performing the activity involves performing the activity self-organized, and initiated through the mobile device. It should be noted that this method also works when no cellular functions are available that support the mobile in decision makings (e.g., loss of coverage inside buildings). The user equipment is recognizing sequences of cells independent from the geo-position, time, and signal strength, only by recognizing the recorded patterns as described further below.

In order to ease understanding of this embodiment and further embodiments of the invention, FIG. 1 schematically illustrates one embodiment of a conventional mobile communication system. The mobile communication system includes a radio access network (RAN) 1 which provides mobile computing devices radio access to the system, and a core network (CN) 2 to which the radio access network 1 is connected. The radio access network includes a plurality of base stations 11₁-11₄, and may include at least one base station controller 12 that controls at least some of the base stations 11₁-11₄, and couples the base stations 11₁-11₄ to the core network 2. Just for the purpose of explanation, in FIG. 1 only five base stations 11₁-11₄, and one base station controller 12 are shown. However, the radio access network 1 may include more than five base stations, and more than one base station controller.

Each of the base stations 11₁-11₄ of the radio access network is configured to set up a wireless communication path to at least one mobile computing device MD. The mobile computing device MD, that can also be referred to as user equipment (UE), includes a radio interface that enables the mobile device MD to set up the communication with the base station. In the following, a mobile computing device MD that has set up a wireless connection to one base station will be referred to as connected to that base station. The mobile computing device may include two or more SIM (Subscriber Identity Module) cards that each represent one identity. In this case, the mobile computing device will be referred to as connected to one base station when it has set up a communication using one of these identities. The mobile computing device MD is, for example, a mobile phone (smartphone), a portable computer, a tablet computer, or the like.

Referring to FIG. 1, the core network can be connected to one or more of a data server 31, another radio access network 32, a public switched telephone network (PSTN) 33, a wireless local area network (WLAN) 34, or the like. When the mobile computing device MD is connected to one of the base stations 11₁-11₄, it may use the mobile communication system to transfer data from/to another mobile device in the same radio access network, or to transfer data from/to another device coupled to the core network 2, such as the data server 31, a device coupled to the core network 2 through the other radio access network 32, a device coupled to the core network 2 through the PSTN 33, or a device coupled to the core network through the WLAN 34. Although not illustrated, a plurality of data servers, radio access networks, WLANs, and PSTNS can be connected to the core network 2. The data transferred from/to the mobile device MD when connected to one base station can be speech data when a telephone communication has been set up between the mobile device and the other device, or other data than speech data.

The radio access network can be a conventional 3GPP (3rd Generation Partnership Project) radio access network, such as GSM (Global System for Mobile Communication) BSS (base station subsystem), GERAN (GSM EDGE Radio Access Network), UTRAN (UMTS Terrestrial Radio Access Network), or EUTRAN (Evolved UMTS Terrestrial Radio Access Network). EUTRAN is radio access network of an LTE (Long Term Evolution) or LTE-A (LTE Advanced) system.

In a GSM radio access network the base stations 11₁-11₄ are also referred to as base transceiver stations (BTS). In this type of system, the radio access system with the base stations 11₁-11₄ is often referred to as base station subsystem (BSS). This GSM radio access network provides access to both Circuit Switched (CS) and Packet Switched (PS) core networks.

A GERAN includes, in addition to the basic GSM technology, GPRS (General Packet Radio Service) and EDGE (Enhanced Data Rates for GSM Evolution) technologies and can be connected to a core network implemented as a UMTS (Universal Mobile Telephone Standard) core network, thus enabling real-time IP-based services.

A UTRAN (UMTS Terrestrial Radio Access Network), which is one of the 3rd Generation (3G) Wireless Mobile Communication Technologies, can carry many traffic types from real-time Circuit Switched to IP based Packet Switched. In a UTRAN, the base stations BS are referred to as Nodes (Node Bs), and the base station controller is referred to as Radio Network Controller (RNC).

A EUTRAN does not include a base station controller. The base stations in a EUTRAN are referred to as eNodeBs (evolved Node Bs), and are directly connected to the core network. For example, the base station 115 shown in FIG. 1 may represent an eNodeB of a EUTRAN. The functionality of the base station controller in the radio access systems explained before is performed by the eNodeB and the core network in the EUTRAN. EUTRAN is one of the 4th Generation (4G) Wireless Mobile Communication Technologies that also offers device to device communication, and extended radio offloading technologies including WIFI (WLAN) offloading mechanisms.

The mobile communication network includes a network controller that is configured to take network decisions, such as handover decisions, based on measurement data received from the mobile device. In a radio access network that includes a base station controller (BSC in a GSM BSS, RNC in a UTRAN) the base station controller may be part of the network controller. In a radio access network without base station controller, such as an EUTRAN, the network controller may be realized by the eNodeB and the core network (evolved packet core).

Each base station in a radio access network, such as the base stations 11₁-11₄ in the radio access network 1 illustrated in FIG. 1, cover a certain geographical area referred to as cell (radio cell). In each cell, radio signals from the associated base station are available with a quality (signal strength, signal-to-noise radio) that allows a mobile device to connect to the base station (to set up a wireless communication channel between the mobile device and the base station). When, however, the mobile device moves from a cell associated with a first base station to a cell associated with a second base station, the signal quality of radio signals received by the mobile device from the first base station may become so low that the communication channel cannot be maintained, while the signal quality of radio signals received by the mobile device from the second base station may be good enough for the mobile device to connect to the second base station. In this case the mobile device connects to the second base station before the connection between the mobile device and the first base station is interrupted. This is referred to as handover. Usually, the handover is initiated by the network controller.

A handover may take place between base stations of the same radio access network, or between base stations of different radio access network. In the first case, only the network controller of one radio access network is involved in the handover. In the second case, two network controllers are involved, namely the network controller of the radio access network the mobile devices leaves, and the network controller of the radio access network the mobile device enters. The different radio access networks can be radio access networks of the same type (such as GERAN, UTRAN, EUTRAN, WIFI), or of different types. A handover may also take place between one of the cellular networks explained before and a non-cellular network, such as a WIFI (WLAN). As used herein, the term handover refers to any kind of handover that is a handover in the same radio access network, between different radio access networks, or between a cellular network and a non-cellular network. In the first case, the handover may include an intra-frequency handover, or an inter-frequency handover. In an LTE system, a mobile device may use multiple carriers in one communication session. In this case, the carriers can be handed over (redirected) independently from one base station to another base station. In this case, a handover involves the redirecting of at least one of the multiple carriers.

FIG. 2 schematically shows a geographic area that is covered by a plurality of radio cells 1-5. Each of these cells 1-5 is associated with a base station (not shown), so that a mobile device that is located in the geographic area covered by one cell can connect to the respective base station. The individual cells shown in FIG. 2 can be cells associated with base stations of only one radio access network, or can be radio cells of different radio access networks. The individual radio cells 1-5 can be radio cells of different types of radio access networks. For example, radio cells 1, 2 and 3 shown in FIG. 1 may be radio cells of a EUTRAN (LTE), radio cell 4 may be radio cell of a WLAN, and radio cell 5 may be a radio cell of a GSM radio access network.

Some of these cells 1-5 may overlap. That is, there are geographical positions where radio signals from several base stations are available, so that the mobile device may connect to several base stations. The area labeled with reference character 1′ inside the radio cell 1 is a cell with eICIC (enhanced Inter-Cell Interference Coordination) where interference is reduced and/or actively managed.

The bold line in FIG. 2 represents a route R that a mobile device MD may take in the geographical area covered by the radio cells. On this way, the mobile device crosses several radio cell borders. The geographical positions where the mobile device MD crosses these borders are labeled with A-G in FIG. 2. In a conventional mobile communication system, the following network activities at the positions A-G may occur when the mobile device MD travels along route R:

A: handover to radio cell 1,

B: reducing the transmission power of the mobile device MD,

C: increasing the transmission power of the mobile device MD,

D: handover to radio cell 2,

E: handover to radio cell 1,

F: handover to radio cell 3,

G: handover to radio cell 4.

In a conventional mobile communication system, the handovers and the variation of the power level of the mobile device is triggered by a network controller. The network controller forces the mobile device MD to report the signal quality of radio signals the mobile device MD receives from base stations. Each base station has a unique base station identifier (ID) that is regularly transmitted, so that the individual radio signals received by the mobile device MD can be assigned to the individual base stations. The standard reporting of the mobile computing device MD may contain the signal quality (in particular the received signal strength (RSS)), and the IDs (Identifiers) of the surrounding cells. Within the mobile computing device MD further information can be available such as bit error rates, transmit power, received signal strengths of signals received from several base stations, or the like. Based on these reports, the network controller in a conventional system takes the handover decisions. This decision may be based on an algorithm that intends to connect the mobile device MD to that base stations that provides the highest signal quality at the current position of the mobile device MD.

However, this conventional approach may result in handover decisions that are not absolutely necessary. For example, in embodiment shown in FIG. 2, the route R of the mobile device MD between the handover to the radio cell 2 (at position D), and the handover to the radio cell 1 (at position E) is completely inside radio cell 1, so that (although the mobile device MD may receive the radio signal from the base station associated with the radio cell 2 with a higher signal quality than the radio signal from the base station associated with the radio cell 1) the handovers at D and E are not necessary. There is even the risk that one of these handovers fails, so that the connection of the mobile device to the communication system is interrupted. Thus, preventing unnecessary handovers may reduce the traffic in the communication system, and may even increase the service quality.

One approach to prevent those unnecessary handovers is explained below. This approach is based on the assumption that most users of mobile devices regularly take identical routes, such as from home to work, and back. For example, the route R illustrated in FIG. 2 is a route leading to the home of the user of the mobile device MD. Radio cell 4 is, for example, a WLAN cell in the user's home.

The scenario shown in FIG. 2 may also represent an in-building scenario where different heterogeneous non-cellular systems overlay each other. So the cells 1, 2, 3, 4 and 5 may be Wi-Fi cells which are operated independent from any cellular network operator. The cells 2 and 4 may be setups providing Wi-Fi solutions for restricted usage (e.g., BYOD (Bring Your Own Device) devices controlling machinery).

According to one embodiment of the invention, the mobile device MD, referring to FIG. 3, records a sequence of data sets. Each of these data sets is recorded when a certain activity in the network is performed, such as the activities A-F on the route R shown in FIG. 2. The mobile device further compares the recorded sequence of data sets with stored sequences of data sets. Each of these stored sequences of data sets represents an event (a network activity) similar to the activities A-F explained with reference to FIG. 2. When the recorded sequence of data sets (briefly referenced to as “recorded sequence” in the following) matches one or more sequences of data sets (briefly referred to as “stored sequence” in the following) the mobile computing device performs at least one activity associated with the matching stored sequence. Some examples of those activities the mobile device may perform are explained herein below. For clarification, this is no function of the mobile device's (user equipment's) position, but derived from the event defined through the cells.

For example, referring to FIG. 2, a stored sequence may represent the route R from position A, or from a position before position A, to position C. The at least one activity performed by the mobile device and associated with this stored sequence may include activities of the mobile device MD that prevent the network controller from forcing the mobile device MD to do handovers at positions D and E. This is based on the assumption that the mobile device MD having already taken the route R to position C will proceed on the route R to radio cell 4. Thus, the at least one activity associated with the stored sequence is, in particular, an activity which the mobile device MD performs after it has taken a route corresponding to the stored sequence. The at least one activity associated with the stored sequence may be time-triggered or event-triggered. That is, the mobile device MD may perform the at least one activity after a certain time period after it has detected that the recorded sequence matches the detected sequence or when a pre-defined event is detected.

In the embodiment shown in FIG. 2 performing the activities that prevents the network controller from forcing the mobile device MD to perform the handovers at position D and position E may be event-triggered. For example, the mobile device MD may start the activities when it first receives the radio signal from the base station associated with radio cell 2. Activities, that may prevent the network controller from forcing the mobile device MD to perform the handovers may include, for example, modifying the quality reports forwarded to the network controller. For example, the mobile device MD may not report the radio signal associated with cell 2, or may report a lower signal quality than detected. Further, the mobile device MD may report a higher signal quality of the radio signal associated with radio cell 1 than detected. A report modified in this way will cause the network controller to control the mobile device MD such that it stays connected to the radio cell 1. It should be noted that this is only one of a plurality of possible activities associated with a stored sequence of data sets. Those activities may be defined by the network operator to optimize the behavior of the mobile computing device in his network, in particular for specific cell configurations (for dedicated cell IDs) in the network.

The data sets recorded by the mobile device MD and the data sets stored by the mobile device may include any type of data sets that are suitable to identify a cell configuration. According to one embodiment, these data sets include information on network activities.

These information may include, but are not restricted to, signal levels of radio signals received by the mobile computing device MD, handovers, a variation of the signal power level of the mobile device MD. Usually, at each geographical position the mobile computing device MD receives radio signals from several base stations where the individual radio signals can be distinguished based on the base station IDs. The power level of a radio signal transmitted by one base station decreases as the distance to the base station increases. Thus, based on the power levels of radio signals received from two or more base station a geographical position can be identified. The radio signals used to identify the position may include base station signals from the communication system to which the mobile device has access, but may also include base station signals from a communication system that cannot be accessed by the mobile device (for example, because the user does not have a contract with the provider of a public system or the base station relates to a private system, such as a WLAN). A handover from one radio cell to another radio cell takes place when the mobile device MD is at the border of one radio cell to another radio cell. This border may cover an elongated geographical area. In connection with other parameters, such as signal levels of radio signals, a handover may be used to identify a geographical position. Thus, a data set representing a handover and the other parameters may be used to identify a geographical position. Equivalently, a data set representing a reduction of the mobile device's power level (used to prevent interferences) and other parameters may be used to identify a geographical position.

Recording the data sets by the mobile device in order to generate the recorded sequence may be time-triggered, or event-triggered. In the first case the mobile computing device MD stores data representing the current position of the mobile computing device MD based on the time. For example, the mobile computing device MD stores data sets in pre-defined time intervals. According to one embodiment, these time intervals are between 1 ms and 100s. In the second case, the mobile computing device MD may record a new data set each time a set of parameters (data set) that is recorded to represent one network configuration significantly changes. If, for example, the signal levels of several radio signals are included in a data set to represent one network configuration, and the signal level of one of these signals significantly changes, or a new radio signal is detected, it can be assumed that the position of the mobile device MD has changed. In this case a new parameter set (data set) will be recorded as a representation of the new position. For example, a significant change of a signal level of a radio signal has occurred when the signal level crosses (falls below or rises above) a predefined threshold.

The stored sequence of data sets is basically generated in the same way as the recorded sequence of data sets. That is, the data sets may be recorded time-triggered or event-triggered, and the positions may be represented by at least one of network activities.

Recording the sequence of data sets that is then stored as the stored sequence can be user triggered, or event triggered. For example, a user may trigger the recording of data sets when he starts to take a route that he expects to take repeatedly in the future. This is referred to as recording a route in the following. An event that may trigger recordation of data sets is, for example, when the mobile device MD leaves a radio cell in which it remained for several hours. Leaving one specific radio cell after several hours may indicate that the user leaves his home to go to work, or leaves his work to return home.

Due to the limited memory inside mobile computing devices criteria for the storage of sequences may be defined. One of the ideas of the invention to improve the user data behavior for those areas that are most relevant for the user. That is, routes in those areas that are most relevant for the user may be recorded. Several different criteria may be used to trigger the mobile computing device to store (record) a route.

a. Time triggers and or user interaction may define such an area. For example the user is asked, after staying for some time in a certain area if this is an area where he wishes his mobile computing device MD to optimize his network performance and behavior.

b. Another trigger point could be that a defined list of cell IDs and the surrounding areas are to be optimized and hence recording will be triggered when the mobile device, based on cell IDs, detects that it is in the corresponding area.

c. Indoor configurations change and Wi-Fi or other capillary network configurations are identified.

d. Recording could also be triggered through, e.g. NFC tags. For example, an operator may provide tags to allow the user to mark his office, home and one or more other places to set points where the device records the surrounding cells and defines trigger points.

e. Recording may also be triggered in case of fatal events. In case of such an event a sequence of data sets is stored. Should a similar event occur multiple times recording is triggered. An example could be a repeated handover failure. After n times (with n>1) failures with the same cell ID an automatic improvement would be initiated.

According to one embodiment, a recorded route is analyzed by the mobile computing device MD before the data sets associated with this route, or parts of the data sets associated with this route are stored in the mobile computing device to form a stored sequence. For example, on a long route which a user repeatedly takes there may only be a few network configurations where activities of the mobile computing device MD are required. For example, in the embodiment shown in FIG. 2, activities of the mobile computing device MD may only be required when the mobile computing device MD is between network configurations D and E. In order to detect that the mobile computing device MD is approaching network configuration D, a sequence of several data sets is required. Thus, from a long sequence that represents the recorded route, the mobile device MD may store only a shorter sequence. This shorter sequence is the stored sequence the mobile device MD will use in operation in order to detect whether the mobile computing device MD approaches a certain network configuration, such as network configuration D shown in FIG. 2.

Different algorithms may be employed to detect those network configurations on a recorded route where activities of the mobile computing device MD are required. For example, where handovers failed multiple times, where the handover sequences are extremely dense and repeating in short time, where handovers to previous service cells take place within short period of times, those events might be indicators for non-efficient handover behaviors and trigger activities to optimize the network behavior. An optimization of a network behavior optimization may include triggering the storage of the data sets in case the route is repeated and to store the signal strength and the available IDs of the surrounding base stations, an altering of the network reports could be executed according to additional algorithms and hence result into a self-healing network behavior. Conventional matching (correlation) algorithms, such as algorithm using a maximum likelihood estimation, can be used to compare a recorded sequence with the at least one stored sequence in order to detect whether the recorded sequence matches the stored sequence. Those algorithms are robust enough to correctly detect that the mobile computing device is taking a route that matches a recorded route even when one (or more data sets) of currently recorded data sets is different from the data sets of the stored route.

The method explained before is not restricted to have only one stored sequence stored in the mobile computing device. Instead, several stored sequences can be stored, wherein each of these sequences may represent a route or a part of a route a user of the mobile computing device repeatedly takes. According to one embodiment, the mobile computing device is configured to store between 5 and 10 radio cells where activities are required when the mobile computing device approaches the corresponding cell, and may store between 5 and 10 routes leading to each of these cells. A “stored route” may include between 20 and 50 data sets.

Further, the at least one activity associated with one stored sequence is not restricted to activities in connection with preventing unnecessary handovers. Instead, any kind of useful activity may be taken by the mobile computing device upon detecting that a user has taken a route associated with the stored sequence. It should be noted that although at least some of these activities may be suitable to reduce the network activity in a communication system, the decision to take these activities is taken by the mobile device based on comparing the recorded sequence with the at least one stored sequence. That is, the decision can be taken independent from a network controller, if there is any. In particular, the decision to perform the activity is based only on data (information) available in the mobile device. Some examples of activities that may be taken by the mobile device are briefly disclosed below.

According to one embodiment, activities associated with a stored sequence include preparing for a handover. Assume that there is a chain of small cells along a stored route so that a plurality of handovers (such as between 10 and 20) are required within a short distance (such as between 1 km and 2 km) when the mobile device travels along this route. These handovers are predictable. That is, upon detection that the mobile device travels along this route the mobile device may prepare for the handover already before it reaches a position where it may be forced by a network controller to do the handover. Those preparations may include to power-up capillary or cellular network interfaces, and to leave idle or power-down states. Those activities may also include pre-tuning of synthesizers and power amplifiers towards specific configurations. This may further include the preparation of keys for cells that are not provided by the cellular operator and to grant access.

According to one embodiment, the at least one activity associated with a stored sequence includes searching for a predefined radio cell. For example, referring to FIG. 2, the mobile computing device MD using a stored sequence may detect that it approaches radio cell 4 (e.g., the home WLAN cell). In this case, the activity associated with the stored sequence 4 may include searching for this radio cell 4 in order to connect to this radio cell 4 as soon as possible.

According to one another embodiment, the mobile device MD remotely controls electronic devices through the mobile communication system at the network configuration it approaches. When, for example, the mobile computing device MD detects that it approaches a certain network configuration, which may be at the home of the user or inside a building, for instances, it may cause a facility unit (home controller, home control unit) to switch on lights, turn up the heating system, or open doors, for example. Those activities may even be triggered when the user is relatively far away from the place of action.

In an ever growing number of companies employees may bring their own mobile device and use the mobile device on the job. In this case, different environments may be installed on the device, one for private use, and one for professional use. According to one embodiment, the at least one activity associated with a stored sequence is to switch between these environments. For example, when the mobile computing device MD detects that the user approaches work, it may switch to the work environment, and when the mobile device detects that the user approaches home, it may switch to the private environment.

Further, through the recording of data sets the entrance to the home area can be triggered automatically and proactive. The leaving of the area could take place when a distance to the area is done and hence the cell configuration around the home is providing thresholds for triggering.

The at least one activity associated with a stored sequence can be defined by the mobile computing device, or can be defined by a user. For example, activities associated with the operation of the mobile computing device in the communication system will be defined by the mobile computing device MD itself. These activities may include activities in connection with preventing handovers (as discussed above) or other network related actions, such as actions in connection with improving the service quality.

According to one embodiment, e.g. if the mobile computing device MD approaches its storage limit, user interaction will allow the user to decide which routes he would like to optimize. For example, this user interaction allows a user to select the most relevant areas, e.g., by offering selection lists where he can select: home, work, sports, or the like

According to one another embodiment, the user may define activities associated with the stored sequence. In this case, after recording a route, the user may identify certain network configurations on the route and may associate certain activities with these network configurations. The mobile computing device MD then stores those sequences of the route that are required to detect that the mobile computing device MD approaches a specific network configuration, and associates the activity defined by the user with this stored sequence.

In each of the cases explained above the complete processing can be done fully in the mobile device. That is, the mobile device stores at least one sequence of data sets, compares the at least one stored sequence with a recorded sequence, and performs at least one activity associated with the stored sequence when the stored sequence and the recorded sequence match. That is, the decision to perform the at least one activity is taken by the mobile independent of another entity (such as, e.g., a network controller), that is, without interaction with another entity.

Furthermore, the stored and the recorded sequence are based on measuring a user behavior by recording typical changes in radio cells along a route. Those changes may include handovers, changes in the power level of received signal, e.g., eICIC. In particular, the method is not restricted to rely on only one technology for obtaining the data sets associated with the recorded and sored sequences. For example, not only data available from one technology (such as LTE) are used to create the data sets, but any type of network activity in any type of technology may be used. That is, the method relies on heterogeneous network technologies. Further, the data sets may not include only data on those networks to which the mobile device has access, but any network “visible” to the mobile device may be used. Further, the method is not restricted to public communication systems, but may be used in private systems as well. For example, in an industry or office building where several WLANs are available and where a user of the mobile device repeatedly takes the same route, the method may be used to recognize the route and to prepare for a handover between the individual WLANs. As the method can rely on network activities and network configurations for recognizing a route, the method is independent of GPS (Global Positioning System) data.

The method has an additional innovation factor, that of preventing handover failures which may be provided as a service for the operators. Examples: report 5 times handover failure to my operator; mobile device agrees with the operator on allowed fixes.

The method may create a service and measure the networks failure levels. For example, the method provides a service quality index and it can show to the customers the benchmarks and indicate how good a network is compared to others.

The method explained herein before can be fully implemented using a software (mobile application) running on the mobile computing device.

1. A method, comprising:
recording a sequence of data sets by a mobile computing device to obtain a recorded sequence of data sets in a heterogeneous communication system that uses different communication technologies;
comparing by the mobile computing device the recorded sequence of data sets with a stored sequence of data sets;
performing by the mobile device at least one activity associated with the stored sequence of data sets when the mobile computing device detects that the recorded sequence of data sets matches the stored sequence of data sets.

2. The method of claim 1,
wherein performing the at least one activity by the mobile device comprises performing the activity only based on data available in the mobile device.

3. The method of claim 1,
wherein performing the at least one activity by the mobile device comprises performing the activity independent of an interaction with another entity.

4. The method of claim 1,
wherein comparing comprises comparing the recorded sequence with a plurality of stored sequence, and
wherein the mobile computing device performs at least one activity associated with one of the plurality of stored sequences when the one of the plurality of stored sequences matches the recorded sequence.

5. The method of claim 1,
wherein recording the data sets includes at least one of:
recording handovers of the mobile computing device between base stations,
recording base station radio profiles,
recording changes in a power level of the mobile computing device,
recording signals from communication systems that cannot be accessed by the mobile device, and
recording base station identifiers (IDs).

6. (canceled)

7. The method of claim 1, wherein activities associated with the stored sequence of data sets comprise:
filtering signal quality reports transmitted to a network controller in order to prevent a handover.

8. The method of claim 7, wherein filtering the signal quality reports comprises one of:
suppressing the signal quality reports; or
modifying the signal quality reports.

9. The method of claim 1, wherein activities associated with the stored sequence of data sets comprise:
searching for a predefined base station.

10. The method of claim 9, wherein the predefined base station is a WLAN base station.

11. The method of claim 1, wherein activities associated with the stored sequence of data sets comprise:
remotely controlling at least one electronic device by the mobile computing device through a communication network.

12. The method of claim 11, wherein the at least one electronic device includes a home control unit that is configured to control at least one of an electric light, an automatic door opener, and a heating system in a building.

13. The method of claim 1, wherein activities associated with the stored sequence of data sets comprise:
activating or deactivating applications running on the mobile computing device.

14. The method of claim 1, wherein activities associated with the stored sequence of data sets comprise:
preparing for a handover.

15. A computer program comprising software code adapted to perform method steps in accordance with one of the preceding claims.

16. The method of claim 1, wherein the heterogeneous communication system comprises at least one cellular network and at least one non-cellular network.

17. The method of claim 16,
wherein the at least one cellular network is one of a 2G, 3G and LTE network, and
wherein the at least one non-cellular network is one of a Wi-Fi and a capillary network.

18. The method of claim 1, wherein recording the data sets includes recording the data sets based on a trigger event.

19. The method of claim 18, wherein the trigger event comprises at least one of:
a detected change of a configuration of a capillary network; and
detecting an NFC tag.
